(19) United States
(12) Patent Application Publication
(10) Pub. No.: US 2011/0305873 A1
(43) Pub. Date: Dec. 15, 2011

(54) COMPOSITION AND METHOD FOR APPLYING A PROTECTIVE COATING

(75) Inventors: Tamara Jean Muth, Ballston Lake, NY (US); James Anthony Ruud, Delmar, NY (US); Leonardo Ajdelsztajn, Niskayuna, NY (US); Prajina Bhattacharya, Bangalore (IN)

(73) Assignee: GENERAL ELECTRIC COMPANY, Schenectady, NY (US)

(21) Appl. No.: 12/797,091

(22) Filed: Jun. 9, 2010

(51) Int. Cl. B32B 3/00; C23C 4/10; C23C 4/06; B05B 7/16

(52) U.S. Cl. 428/143; 118/300; 427/450; 427/451

(57) ABSTRACT

A coating composition includes a cermet material having metal carbide phase particles with an average size of less than 5 microns. The coating has an average surface roughness of less than approximately 5 microns. A system for applying a coating to a substrate includes a spray gun configured for use with a high velocity oxygen or high velocity air fuel system. The system further includes a cermet material supplied to the spray gun, wherein the cermet material includes at least approximately 34 percent by weight of a metal carbide phase having an average particle size of less than or equal to approximately 5 microns. The metal carbide phase is dispersed in a liquid selected from the group consisting of water, alcohol, an organic combustible liquid, or an organic incombustible liquid.

### FEDERAL RESEARCH STATEMENT

This invention was made with Government support under contract number 70NANB7H7009 awarded by the U.S. NIST Advanced Technology Program. The Government may have certain rights in the invention.

### FIELD OF THE INVENTION

The present invention generally involves compositions and methods for applying coatings to various articles. Particular embodiments of the present invention include a composition, system, and method for applying an erosion resistant protective coating to a substrate exposed to high temperature and erosive environments.

### BACKGROUND OF THE INVENTION

Industrial and commercial equipment is often operated in high temperature, pressure, and/or flow environments. For example, in a conventional steam cycle, a steam generator produces high temperature and pressure steam that flows through a steam turbine to produce work. The high temperature and pressure steam often includes entrained boiler scale, moisture, and/or other solid particles traveling at speeds around 1,000 feet per second. The impact of the boiler scale, moisture, and/or other solid particles on the turbine blades or nozzles cause solid particle erosion. Solid particle erosion creates localized surface roughness that changes the surface profile of the aerodynamic surfaces of the blades or nozzles, thus reducing the aerodynamic efficiency of the blades or nozzles.

Over the typical 30-year life of the steam turbine, the decrease in the aerodynamic efficiency caused by erosion and/or corrosion may be substantial. As a result, coatings may be applied to component surfaces to protect the components from the harsh environmental conditions.

Various systems and methods are known in the art for applying protective coatings. For example, physical vapor deposition (PVD) techniques have been used to apply coatings that protect the underlying component surface from erosion. However, PVD coatings are often very thin, e.g., less than about 50 microns (0.05 mm). As a result, erosive particles may cause an elastic-plastic indentation zone. The elastic-plastic indentation zone is typically ten times the size of the impact and may extend beyond the PVD coating thickness to plastically deform the underlying component surface. This becomes significant as the angle of impact increases. The deformation may cause the PVD coatings to peel or otherwise degrade, exposing the underlying component surface to much greater erosion from the solid particles.

Vacuum plasma spray (VPS) and low pressure plasma spray (LPPS) techniques produce a dense and relatively oxide-free coating. However, these systems require a significant capital outlay, high power consumption equipment, multiple spraying and vacuum chambers, and time consuming process cycles. As a result, VPS and LPPS techniques may be economically unfeasible.

Air plasma spray (APS) techniques deposit coatings at an elevated temperature in the presence of air and involve less expensive equipment than VPS and LPPS techniques. However, APS coatings inherently contain a high oxide content and are prone to thermal growth oxidation (TGO) because they do not form a continuous oxide scale. In addition, APS coatings are relatively low in density due to the relatively low velocity of the powders being applied, resulting in high porosity in the coating. As a result, APS coatings do not typically possess satisfactory resistance to erosion/corrosion.

High velocity oxygen fuel (HVOF) and high velocity air fuel (HVAF) techniques have also been used to apply coatings that protect the underlying component surface from erosion. In each technique, a gas or liquid fuel is combusted with oxygen (HVOF) or air (HVAF) to produce a high velocity exhaust stream. A coating powder injected into the exhaust stream is heated and accelerated toward the desired substrate at speeds exceeding 2,000 feet per second. The resulting coating is typically dense compared to other application techniques. However, feedstock particles having an average diameter smaller than 20 to 40 microns tend to clog or conglomerate in conventional HVOF and HVAF equipment. As a result, HVOF and HVAF techniques do not effectively and consistently produce a coating with a surface roughness Ra (Arithmetic Average Roughness as determined from ANSI/ASME Standard B461-1985) less than 5 to 20 microns.

Therefore the need exists for an improved composition, system, and method for applying that composition to a component substrate. Ideally, the composition will possess high resistance to erosion and/or corrosion and have a low surface roughness.

### BRIEF DESCRIPTION OF THE INVENTION

Aspects and advantages of the invention are set forth below in the following description, or may be obvious from the description, or may be learned through practice of the invention.

One embodiment of the present invention is a coating that includes a cermet material having metal carbide phase particles with an average size of less than 5 microns. The coating has an average surface roughness of less than approximately 5 microns.

An alternate embodiment of the present invention is a system for applying a coating to a substrate. The system includes a spray gun configured for use with a high velocity oxygen or high velocity air fuel system. The system further includes a cermet material supplied to the spray gun, wherein the cermet material includes at least approximately 34 percent by weight of a metal carbide phase having an average particle size of less than or equal to approximately 5 microns. The metal carbide phase is dispersed in a liquid selected from the group consisting of water, alcohol, an organic combustible liquid, or an organic incombustible liquid.

A further embodiment of the present invention includes a method for coating a substrate. The method includes dispersing a cermet material in a liquid selected from the group consisting of water, alcohol, an organic combustible liquid, or an organic incombustible liquid. The cermet material includes at least approximately 34 percent by weight of a metal carbide phase having an average particle size of less than or equal to approximately 5 microns. The method farther includes spraying the cermet material onto the substrate using a high velocity oxygen or high velocity air fuel system.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is an illustration of one embodiment of the present invention; and

FIG. 2 is a graph of test results comparing embodiments of the present invention to a prior art coating.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

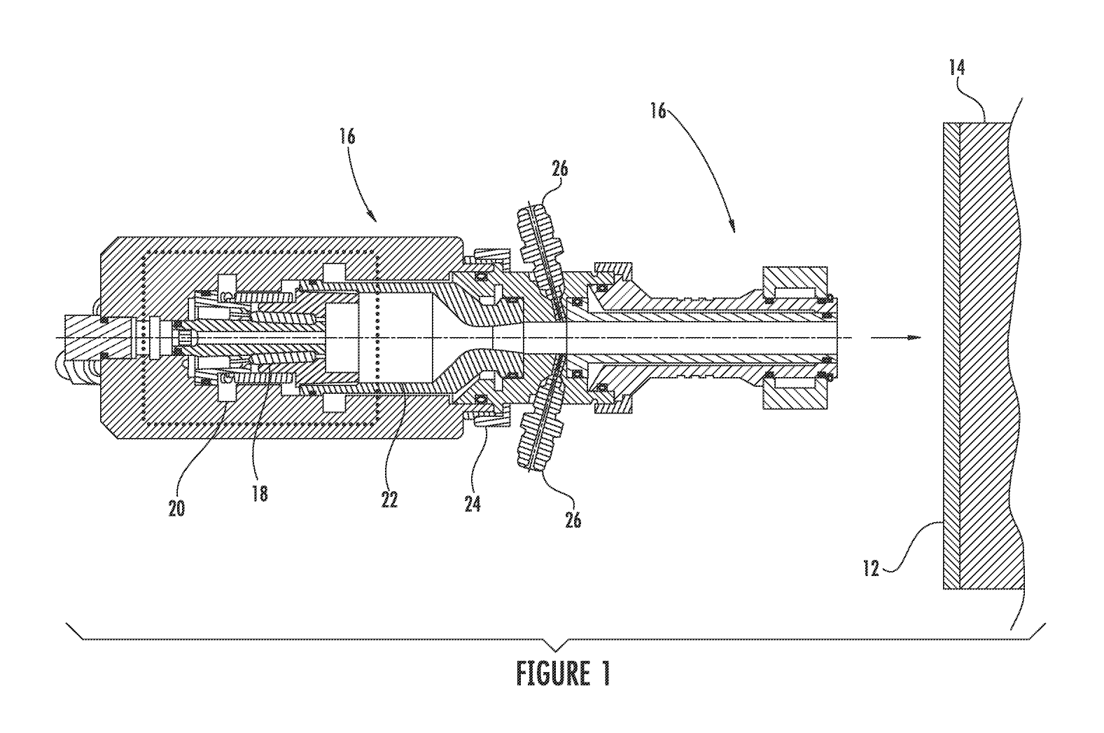

FIG. 1 shows a simplified diagram of a system 10 for applying a coating 12 to a substrate 14 according to one embodiment of the present invention. The system 10 generally includes a spray gun 16 configured for use with a high velocity oxygen fuel (HVOF) or high velocity air fuel (HVAF) system. Although various HVOF and HVAF spray guns are known in the art and may be used within the scope of various embodiments of the present invention, the exemplary spray gun 16 shown in FIG. 1 generally includes a plurality of circumferentially spaced injection ports 18 that combine either gas or liquid fuel with oxygen 20 for an HVOF system or air for an HVAF system. The spray gun 16 ignites the fuel/oxygen or fuel/air mixture in a combustion chamber 22, and a nozzle 24 downstream of the combustion chamber 22 accelerates the combustion gases to velocities in excess of 2,000 feet per second.

As shown in FIG. 1, the spray gun 16 includes a plurality of circumferentially spaced particle injectors 26 downstream of the nozzle 24. The circumferentially spaced particle injectors 26 supply a ceramic material composition into the flow of combustion gases. The combustion gases melt and accelerate the ceramic material composition. The molten ceramic material composition exits the spray gun to produce the coating 12 on the substrate 14.

The coating 12 produced from the ceramic material composition may be referred to as a “cermet” material in that it generally includes a metal carbide phase with a metallic binder. As will be described, the metal carbide phase in the ceramic material composition includes particles having an average particle size of less than or equal to approximately 10 microns. In particular embodiments, the metal carbide phase particles in the ceramic material composition may have an average particle size of less than or equal to approximately 5 microns or less than or equal to approximately 2 microns.

The ceramic composition material is dispersed in a liquid before being injected into the stream of combustion gases in the spray gun 16 to overcome the previous difficulties experienced with supplying 5 to 10 micron-sized particles to HVOF or HVAF spray guns. Suitable liquids for dispersing the ceramic material include, for example, water, alcohol, an organic combustible liquid, an organic incombustible liquid, or combinations thereof. More specifically, suitable liquids for dispersing the ceramic material composition may include water, ethanol, methanol, hexane, ethylene glycol, or combinations thereof. The reduced average particle size of the metal carbide phase particles dispersed in the liquid allows the system 10 to produce a resulting coating 12 with an average surface roughness Ra (Arithmetic Average Roughness as determined from ANSI/ASME Standard B461-1985) of less than approximately 5 microns, and in particular embodiments less than approximately 2 microns or 1 micron.

The metal carbide phase dispersed in the ceramic material composition may include any of a variety of metal carbide particles. Examples of metal carbide particles within the scope of the present invention include chromium carbide, tantalum carbide, hafnium carbide, niobium carbide, vanadium carbide, tungsten carbide, and combinations thereof. In particular embodiments in which the metal carbide particles are a chromium carbide, the chromium carbide may be any of Cr₃C₂, Cr₇C₃, Cr₂₃C₆, and mixtures thereof. In particular embodiments, the resulting coating 12 may comprise more than approximately 34 percent by weight metal carbide or more than approximately 45 percent by weight metal carbide.

The metallic binder dispersed in the ceramic material composition may include various alloys having the general formula MCrAlX. In this formula, “M” may be iron, cobalt, nickel, or any combination thereof, and “X” may be a rare earth element. As used herein, the term “rare earth element” refers to a single rare earth element, or a combination of rare earth elements. Examples of rare earth elements include lanthanum, cerium, praseodymium, neodymium, samarium, europium, gadolinium, terbium, dysprosium, holmium, erbium, thulium, ytterbium, lutetium, scandium, and yttrium. In specific embodiments, the rare earth element may be yttrium, hafnium, lanthanum, cerium, or scandium, or some combination thereof. Yttrium is often the most preferred rare earth element. For example, in particular embodiments, the MCrAlX metallic binder may include approximately 17 to 23 percent by weight chromium, approximately 4 to 13 percent by weight aluminum, approximately 0.1 to 2 percent by weight yttrium, and the balance constituting M. In other particular embodiments, M may be a mixture of nickel and cobalt, wherein the ratio of nickel to cobalt is in the range of approximately 10:90 to 90:10 by weight. However, it should be noted that the specific alloy composition for the MCrAlX metallic binder can vary significantly and will depend in large part on the end use intended for the coating material.

In alternate embodiments, the metallic binder dispersed in the ceramic material composition may include metal carbide particles dispersed in an alloy. For example, in one particular embodiment, the alloy may comprise nickel-chromium. For this embodiment, the proportion of nickel and chromium in the alloy may vary to some degree, depending in large part on the intended end use of the coating. For example, the alloy may include approximately 68 to 78 percent by weight nickel or approximately 72 to 76 percent by weight nickel. Similarly, the alloy may include approximately 14 to 22 percent by weight chromium or approximately 14 to 18 percent by weight chromium. The specific level of nickel and chromium for any embodiment may be modified to enhance the desired coating properties, such as ductility and hardness.

As may be apparent from the above description of the possible metal carbide phase particles and metallic binders within the scope of the present invention, chromium may be present in various forms. For example, a first portion of the chromium may be combined with carbide to form the metal carbide phase. A second portion of the chromium may be alloyed with the metal(s), such as nickel, to form the metallic binder. Moreover, the chromium carbide material may be distributed substantially uniformly within the metal carbide phase. Methods for preparing the metal carbide phase and metallic binder are generally known in the art, and they depend on the specific constituents included in specific embodiments, the method in which the material is applied to an article, and the ultimate end use for the article.

The coating of the subject invention may be applied using either HVOF or HVAF processes. However, the HVOF and HVAF processes are distinct thermal spray processes based on different combustion systems and may produce coatings with distinct microstructures. The HVOF process, by the nature of combustion with oxygen, produces very high combustion temperatures that result in high particle temperatures. Carbide particles can undergo oxidation or dissolution in the metallic binder matrix, which can affect the properties of the coatings. The HVAF process, in contrast, operates in a process range described as “warm kinetic spraying” with reduced combustion and particle temperatures. The coatings produced by HVAF processes using large powder feedstock material have been observed to contain reduced oxygen contents compared with HVOF coatings, which is particularly applicable to spraying of fine particles. However, reduced combustion temperatures can limit the degree of carbide incorporation within the coating or the mechanical strength of the cermet microstructure.

In any particular embodiment, and especially in the case of a chromium-based metal carbide, the amount of the metallic binder within the overall composition is controlled so as to optimize the property balance between ductility and hardness. As an example, greater proportions of the metallic binder will often enhance ductility, but may detract from coating hardness. Moreover, while lower proportions of the metallic binder may ensure coating hardness, very low levels may make the coating brittle.

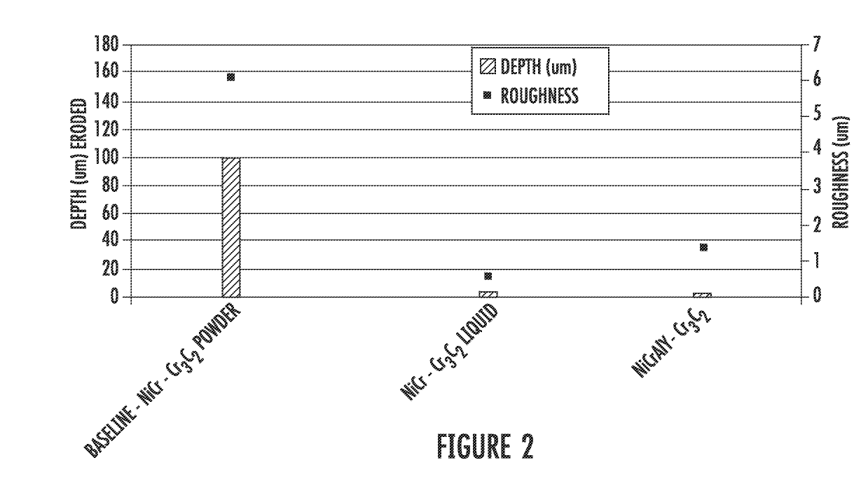

FIG. 2 provides a graphic representation of test results comparing embodiments of the present invention to a prior art coating. The tested coatings were exposed to an environment of 1,200 degrees Fahrenheit with an erodent flux of 400 grams of magnetite particles with an average particle size of 40 microns flowing at approximately 1,000 feet per second at an impingement angle of 30 degrees.

The baseline coating was produced from an HVOF application of NiCr—Cr₃C₂ powder having an average particle size of 20 to 40 microns. The baseline composition initially had an average surface roughness Ra of approximately 6 microns.

One embodiment within the scope of the present invention was produced from an HVOF application of NiCr—Cr₃C₂ powder having an average particle size of approximately 2 microns. The NiCr—Cr₃C₂ powder was mixed with water at 10 percent by weight of solids and supplied to a Diamondjet 2600 HVOF gun. The resulting coating had an initial thickness of approximately 150 microns and an average surface roughness Ra of approximately 0.6 microns. The average carbide size in the coating was approximately 1.2 microns, determined from the mean linear intercept from analysis of a cross-sectional scanning electron microscopy image. The metal carbide phase in the coating was determined to be approximately 40 percent by volume from analysis of the cross-sectional image, which corresponds to approximately 34 percent by weight of carbide.

A second embodiment within the scope of the present invention was produced from an HVOF application of NiCrAlY—Cr₃C₂ powder having an average carbide particle size of less than approximately 5 microns. The ceramic material composition was comprised of approximately 20 percent by weight metallic binder (NiCrAlY) and approximately 80 percent by weight metal carbide phase (Cr₃C₂). The powder was agglomerated to a size range of between about 10 to 60 microns in diameter and supplied to a Diamondjet 2600 HVOF torch with an air carrier gas to produce a coating on a substrate. The coating was approximately 250 microns in thickness. The average carbide particle size in the coating was approximately 2 microns, determined from the mean linear intercept from analysis of a cross-sectional scanning electron microscopy image. The metal carbide phase in the coating was determined to be approximately 42 percent by volume from analysis of the cross-sectional image, which corresponds to approximately 36 percent by weight of carbide. The average surface roughness Ra of the coating was approximately 1.4 microns.

A third embodiment within the scope of the present invention was produced from an HVAF application of NiCr—Cr₃C₂ powder. The metallic binder was further comprised of approximately 80 percent by weight nickel and approximately 20 percent by weight chromium. The ceramic material composition was milled for approximately 168 hours to produce an average particle size of less than 5 microns. The powder was mixed with water to produce a suspension that contained 10 percent by weight of powder. A coating was deposited using a Keramatico 9300 HVAF spray process with a mixture of propylene fuel and air at a combustion pressure of 70 pounds per square inch. The HVAF gun was rastered across a stainless steel substrate at 600 mm/s and a gun to substrate distance of 3 inches to produce a cermet coating. The cermet coating had an initial thickness of approximately 120 microns. The average carbide size in the coating was approximately 1.5 microns, determined from the mean linear intercept from analysis of a cross-sectional scanning electron microscopy image. The metal carbide phase in the coating was determined to be approximately 52 percent by volume from analysis of the cross-sectional image, which corresponds to approximately 45 percent by weight of carbide. The average surface roughness Ra of the coating was approximately 1.4 microns.

As shown in FIG. 2, the baseline composition experienced erosion to a level of approximately 100 microns. In contrast, the embodiments of the present invention experienced no measurable erosion during the test, demonstrating superior protection against erosion compared to the baseline composition. For example, in particular embodiments within the scope of the present invention, the cermet coating may produce a cermet material with an initial mass and an initial average thickness over a predetermined area. After exposure of the predetermined area to the conditions described with respect to FIG. 2, the cermet material may have a second mass and second average thickness in the predetermined area that is at least 95%, at least 98%, or substantially equal to the initial mass and initial average thickness, respectively.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A coating, comprising:
a. a cermet material comprising metal carbide phase particles having an average size of less than 5 microns; and
b. an average surface roughness of less than approximately 5 microns.

2. The coating as in claim 1, wherein the metal carbide phase particles have an average size of less than or equal to approximately 2 microns.

3. The coating as in claim 1, wherein the average surface roughness is less than approximately 2 microns.

4. The coating as in claim 1, wherein the cermet material has an initial mass over a predetermined area and a second mass over the predetermined area after the cermet material in the predetermined area has been exposed to a flux of 400 grams of 40 micron magnetite particles at an impingement angle of 30 degrees, wherein the second mass is at least 95% of the initial mass.

5. The coating as in claim 4, wherein the second mass is at least 98% of the initial mass.

6. The coating as in claim 4, wherein the second mass is substantially equal to the initial mass.

7. The coating as in claim 1, wherein the cermet material has an initial average thickness over a predetermined area and a second average thickness over the predetermined area after the cermet material in the predetermined area has been exposed to a flux of 400 grams of 40 micron magnetite particles at an impingement angle of 30 degrees, wherein the second average thickness is at least 95% of the initial average thickness.

8. The coating as in claim 7, wherein the second average thickness is at least 98% of the initial average thickness.

9. The coating as in claim 7, wherein the second average thickness is substantially equal to the initial average thickness.

10. A system for applying a coating to a substrate, comprising:
a. a spray gun configured for use with a high velocity oxygen or high velocity air fuel system; and
b. a cermet material supplied to the spray gun, wherein the cermet material comprises at least approximately 34 percent by weight of a metal carbide phase having an average particle size of less than or equal to approximately 5 microns, and wherein the metal carbide phase is dispersed in a liquid selected from the group consisting of water, alcohol, an organic combustible liquid, or an organic incombustible liquid.

11. The system as in claim 10, wherein the metal carbide phase is selected from the group consisting of chromium carbide, tantalum carbide, hafnium carbide, niobium carbide, vanadium carbide, tungsten carbide, and combinations thereof.

12. The system as in claim 10, wherein the metal carbide phase comprises a chromium carbide selected from the group consisting of Cr₃C₂, Cr₇C₃, Cr₂₃C₆, and combinations thereof.

13. The system as in claim 10, wherein the cermet material comprises an alloy having the formula MCrAlX, where M is selected from the group consisting of iron, cobalt, nickel, and combinations thereof and X is at least one rare earth element.

14. The system as in claim 10, wherein the cermet material comprises approximately 68 to 78 percent by weight of nickel.

15. A method for coating a substrate, comprising:
a. dispersing a cermet material in a liquid selected from the group consisting of water, alcohol, an organic combustible liquid, or an organic incombustible liquid, wherein the cermet material is comprised of at least approximately 34 percent by weight of a metal carbide phase having an average particle size of less than or equal to approximately 5 microns; and
b. spraying the cermet material onto the substrate using a high velocity oxygen or high velocity air fuel system.

16. The method as in claim 15, further including forming a coating on the substrate, wherein the coating has an average surface roughness of less than approximately 5 microns.

17. The method as in claim 15, further including dispersing the cermet material, wherein the metal carbide phase is selected from the group consisting of chromium carbide, tantalum carbide, hafnium carbide, niobium carbide, vanadium carbide, tungsten carbide, and combinations thereof.

18. The method as in claim 15, further including dispersing the cermet material, wherein the cermet material comprises an alloy having the formula MCrAlX, where M is selected from the group consisting of iron, cobalt, nickel, or combinations thereof and X is at least one rare earth element.

19. The method as in claim 15, further including dispersing the cermet material, wherein the cermet material comprises approximately 68 to 78 percent by weight of nickel.

20. The method as in claim 15, further including dispersing the cermet material, wherein the cermet material comprises NiCrAlY.
